(19) United States
(12) Patent Application Publication
(10) Pub. No.: US 2009/0039578 A1
(43) Pub. Date: Feb. 12, 2009

(54) TENSION-COMPRESSION SPRING

(76) Inventor: Evgeny Rivin, West Bloomfield, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/174,101

(22) Filed: Jul. 16, 2008

Related U.S. Application Data
(60) Provisional application No. 60/959,730, filed on Jul. 16, 2007.

(51) Int. Cl. F16F 3/08

(52) U.S. Cl. 267/152

(57) ABSTRACT

A tension-compression spring with high utilization of properties of the material from which the spring is fabricated wherein displacements between conforming and interacting beveled surfaces of rings constituting the spring are accommodated by internal shear in an elastomeric layer or layered (laminated) element residing between the conforming and interacting beveled surfaces of the rings.

### RELATED APPLICATION

This application claims priority of U.S. Provisional Patent Application Ser. No. 60/959,730 filed Jul. 16, 2007, which is incorporated herein by reference.

### FIELD OF THE INVENTION

The invention relates to mechanical design elements, such as springs.

### BACKGROUND OF THE INVENTION

Springs are widely used mechanical components. In many mechanical devices, the size and weight of the springs are important characteristics which have to be minimized. Since the spring action is always associated with stressing/unstressing some elements, thus absorbing and releasing potential energy, the size/weight of a spring can be reduced if the stressed elements are uniformly stressed thus fully utilizing the capabilities of the spring material subjected to stress. Many commonly used springs, such as coil springs or slotted springs, do not comply with this requirement.

In coil springs, the potential energy is largely stored by twisting (torsional deformation) of the wire from which the spring is coiled. The torsional deformation is characterized by a non-uniform shear stress distribution across the cross section of the wire, with stresses on the periphery of the cross section being maximal and stresses at the center of the wire cross section being close to zero.

In slotted springs (e.g., see E. Rivin, “Passive Vibration Isolation”, 2003, ASME Press, pp. 220-222), the potential energy is stored in spring elements loaded in bending (tension/compression stresses). Again, the stress distribution is non-uniform, with zero stresses at the neutral surface and maximum stresses in the layers farthest from the neutral surface.

Thus, in both above described springs, significant parts of the spring material are loaded with stresses below their maximum stress, which results in greater size and weight of the spring as compared with cases when the material has stresses of more-or-less uniform magnitudes.

The spring representing the Prior Art for the instant invention is shown in FIG. 1. In this “friction spring”, application of an axial (vertical in FIG. 1) force P causes sliding between similarly beveled contact surfaces 3′ and 4′, 3″ and 4″, 3′″ and 4′″ of adjacent external 1′, 1″ and internal 2′, 2″ rings, respectively. Bases 5 and 6 can be used for packaging of the rings. While two external rings 1′, 1″ and two internal rings 2′, 2″are shown, both smaller and larger numbers of rings can be used. The sliding causes tensile circumferential deformation of external rings 1 and compression circumferential deformation of internal rings 2, thus resulting in storing potential energy due to tensile and compressive stresses in the respective rings. It is obvious that distribution of the tensile and compressive stresses is close to uniform in the cross sections of the rings. Since external (outer) rings are loaded, essentially, in pure tension and internal (inner) rings are loaded, essentially, in pure compression, the name “tension-compression springs” seems to be justified.

Some disadvantages of the design in FIG. 1 are as follows. Since the friction coefficient ƒ in the contact between beveled surfaces 3 and 4 depends on their cleanliness, presence of rust, etc., as well as on the degree of presence of lubricants and on the type of lubricant in the contact, deformation characteristics of the spring may be inconsistent. Also, sliding between surfaces 3, 4 would not start before the driving force in the contact is high enough to overcome static friction force in the contact, thus potentially resulting in a “jerky” behavior of the spring. Deformation characteristics of the spring in FIG. 1 are determined by the bevel angle α. It is sometimes desirable to design a spring with small values of a, at which relatively small axial forces P would cause relatively large deformations of and large stresses in rings 1 and 2. However, at the angle α.<tan⁻¹ƒ, the spring becomes “self-locked” and would not come back to its initial unstressed condition after the axial force P is removed.

The subject invention eliminates the above-listed shortcomings.

### SUMMARY OF THE INVENTION

The instant invention proposes a tension-compression spring in which the necessary displacements between interacting external and internal beveled rings are accommodated by internal shear in an elastomeric (rubber or rubber-like) layer or a layered (laminated) element comprising of alternating layers of elastomeric material and a rigid material, residing between the beveled surfaces of the external and internal rings, without sliding. Accordingly, friction between the contacting convex and concave tapered surfaces is totally eliminated.

Elimination of friction also eliminates the effect of “self-locking” of the spring. Since friction and lubrication are not anymore performance-influencing factors, the consistency of performance characteristics is improved. The disclosed spring is a “solid-state” device not requiring lubrication and a lubrication-delivering system, as well as not requiring sealing of the contact areas between the beveled surfaces of the rings in order to prevent their contamination.

In the preferred embodiment of the invention the elastomeric layered element is placed only between and is attached to the convex and/or concave tapered surfaces of the interacting rings.

In another embodiment of the proposed tension-compression spring, elastomeric layers or laminates are also placed between (and possibly attached to) upper and/or lower bases of the spring and supporting surfaces of the spring, thus preventing friction between the bases of the spring and the support surfaces.

In yet another embodiment of the proposed tension-compression spring, non-contacting surfaces of the ring are coated with a thin layer of the elastomeric material, thus protecting the rings from the environment, e.g. from humidity and from oxygen, the latter property preventing rusting of the spring surfaces. This approach would allow use of a less expensive metal for the tension-compression spring construction.

### BRIEF DESCRIPTION OF THE DRAWINGS

FIG. 1 shows a cross section of the Prior Art tension-compression spring through a plane containing the spring axis wherein elastic external and internal rings having conforming tapered (beveled) surfaces interact through frictional contacts.

FIG. 2 shows a cross section of the proposed tension-compression spring through a plane containing the spring axis wherein elastic external and internal rings with conforming tapered (beveled) surfaces interact through a layer of elastomeric material or a layered element (laminate) placed between the conforming tapered surfaces; a single elastomeric layer is shown.

FIG. 3 shows a cross section through a plane containing the axis of the layered element 7′ in FIG. 2 which is designed as a laminate comprising two elastomeric layers and one intermediate rigid layer.

FIG. 4 shows load-deflection characteristics for the Prior Art tension-compression spring shown in FIG. 1.

FIG. 5 shows load-deflection characteristics for the proposed tension-compression spring shown in FIG. 2.

FIG. 6 shows a cross section through a plane containing the spring axis of the proposed tension-compression spring wherein elastic rings with conforming tapered (beveled) surfaces interact through a one-layer elastomeric layered element placed between the conforming tapered surfaces and the upper and lower base surfaces of the spring are separated from the spring supporting surfaces by a two-layered elastomeric laminate with two layers of rubber and one intermediate layer of a rigid material.

FIG. 7 shows a cross section through a plane containing the spring axis of the proposed tension-compression spring wherein elastic rings with conforming tapered (beveled) surfaces interact through a one-layer elastomeric layered element placed between the conforming tapered surfaces, and the exposed surfaces of the elastic rings are coated with a thin coating of the same or a different elastomeric material.

### DETAILED DESCRIPTION OF THE PREFERRED EMBODIMENTS

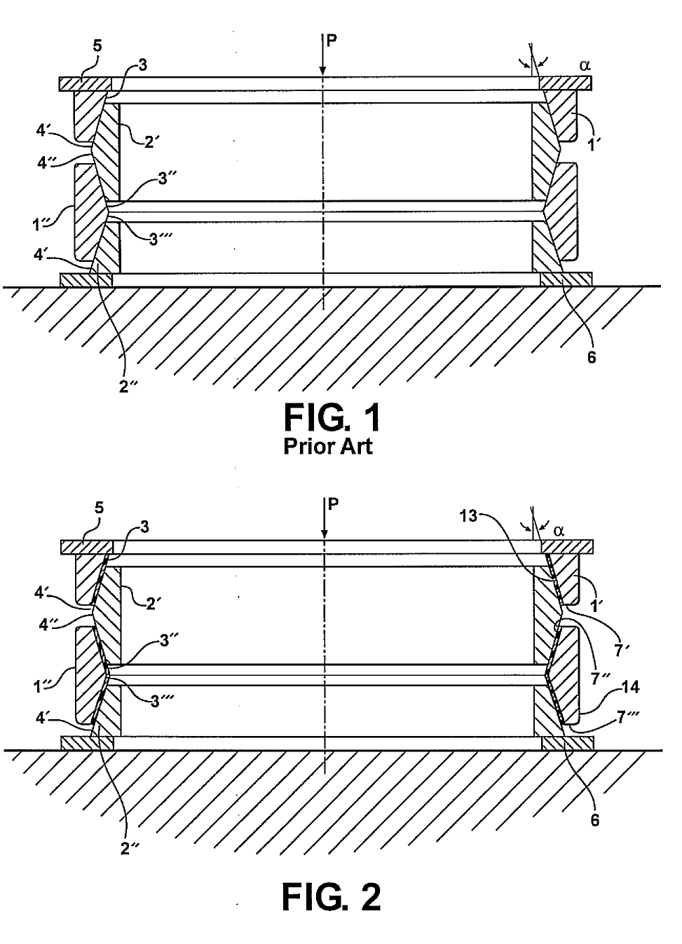

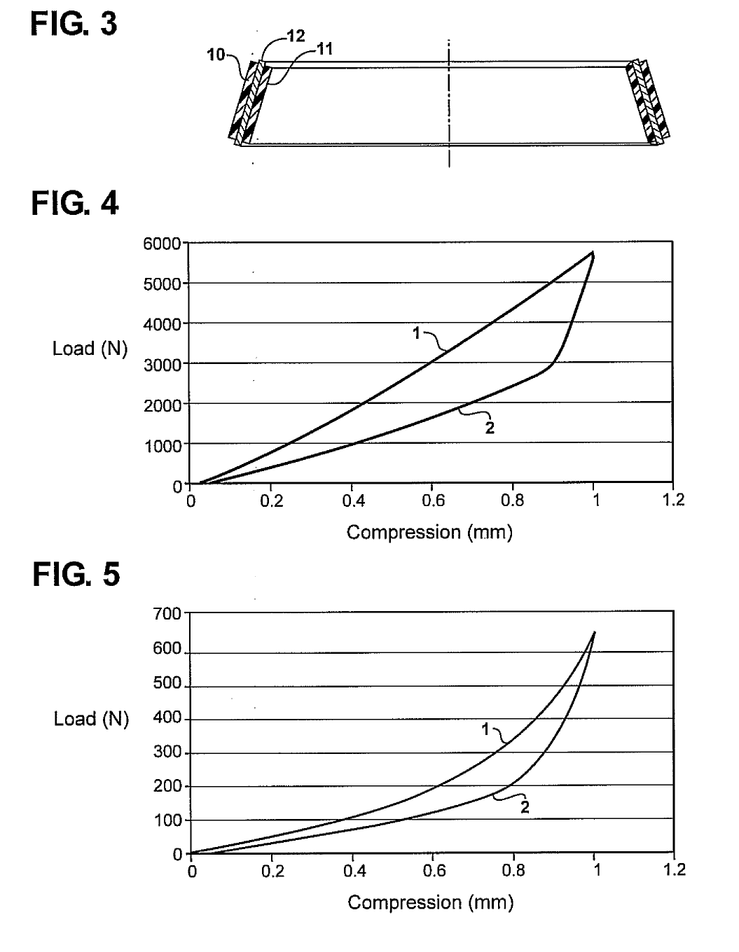

The following specification describes a tension-compression spring shown in FIG. 2 which is free from the shortcomings of the Prior Art tension-compression spring shown in FIG. 1. In FIG. 2, external (outer) rings 1 and internal (inner) rings 2 having conforming and interacting beveled surfaces 3 and 4, respectively, do not contact directly, but interact via layers of elastomeric (rubber or rubber-like) material or via multi-layered elastomer-rigid material (e.g., but not only, metal) laminates 7. In FIG. 2, single elastomeric layers 7 are shown. A cross section of a laminate 7′ comprising two elastomeric layers 10 and 11 bonded to intermediate rigid (e.g., but not necessarily, metal) layer 12 through a plane containing the axis of the spring is shown in FIG. 3. Layers of elastomeric layers or laminates 7 are attached (by bonding, by friction, or by other known techniques) to the beveled surfaces of internal rings 2′ and 2″ and/or of external rings 1′ and 1″.

When the axial force P is applied, external rings 1 move relative to internal rings 2 due to shear deformation of rubber in layers (or laminates) 7, tensile deformation of outer rings 1, and compression deformation of inner rings 2. Since shear resistance of elastomeric layers 7 is very low, regardless of the normal (compressive) forces, the interaction between rings 1 and 2 is very consistent. A smooth movement between the rings starts even for very small forces P, without jerking. Any angle α can be used, without possibility of self-locking. High magnitude contact forces between rings 1 and 2 are easily accommodated by compression of thin elastomeric layers/laminates 7 whose compression strength can be as high as 90,000 psi (600 MPa), e.g. see pp. 250-255 of the above-cited book. Since compression stiffness of the thin elastomeric layers is very high, movement of support surface 5 of the spring induced by axial force P is accompanied by expansion of external rings 1′, 1″, and contraction of internal rings 2′, 2″, starting from the smallest magnitudes of force P. A “thin” elastomeric layer in this specification is defined as a layer whose thickness is smaller than one fifth, preferably thinner than one tenth of the smallest of the other two dimensions of the layer (width and length).

FIGS. 4 and 5 show the load-deflection characteristics of the Prior Art spring of FIG. 1 (α=15°) and the proposed tension-compression spring of FIG. 2 (α=5°), respectively, with lines 1 representing loading (increasing load P) and lines 2 representing unloading (decreasing load P). Both springs have the outer diameter 25 mm. It can be seen that about the same deformation of the spring (˜1 mm) is achieved by application of force P≈5700 N for the Prior Art spring, but only P≈650 N, about ten times lower, for the proposed spring since its mechanical advantage is increased by using smaller angle α without a fear of “self-locking”. Comparison of FIG. 4 with FIG. 5 also shows that the characteristic of the proposed spring design is smoother and has a smaller hysteresis loop, thus indicating lower energy dissipation. It has to be noted, however, that the energy dissipation of the spring shown in FIG. 2 can be adjusted as needed by a judicious selection of material characteristics of the elastomeric layers.

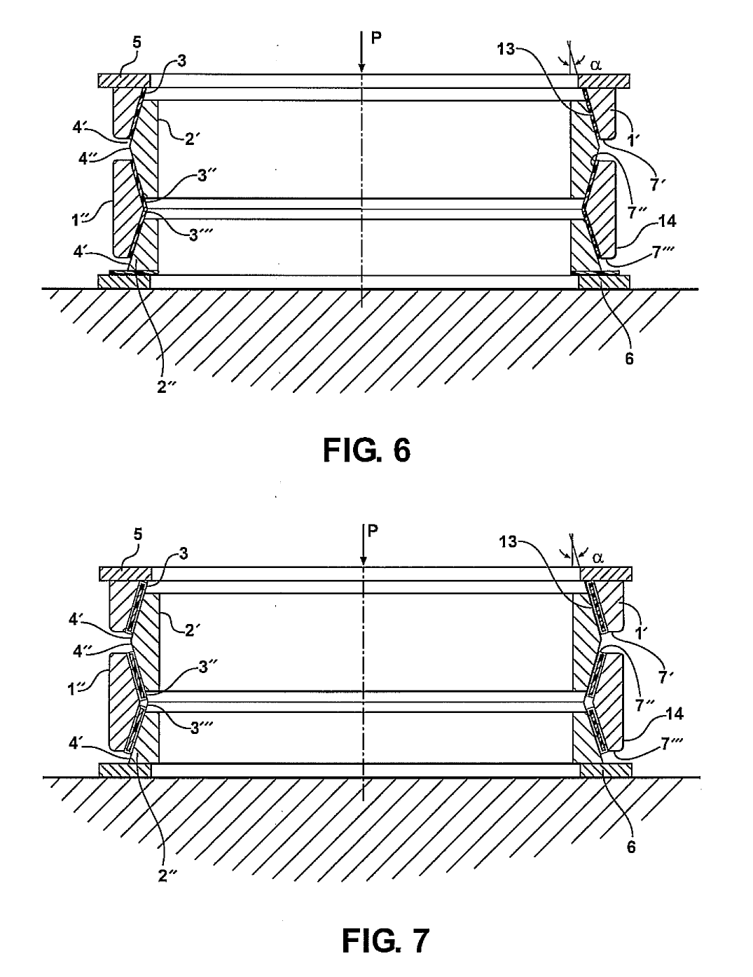

While interaction of rings 1 and 2 is effected via shear and compression of elastomeric layers 7, interaction between the base (end) surfaces 13, 14 of the tension-compression spring in FIG. 2 and its supports 5 and 6 is frictional, metal-to-metal, interaction. Under force P the end ring 1′ expands and end ring 2″ contracts. These movements are accommodated by friction between end surface 13 of ring 1′ and upper support 5 and between end surface 14 of ring 2″ and lower support 6. Although these movements are relatively small, they might be undesirable. In the embodiment shown in FIG. 6, these interactions are accommodated by shear deformations in elastomeric layer/laminate 15 spaced between upper support 5 and end surface 13 of ring 1′ and elastomeric layer/laminate 16 spaced between lower support 6 and end surface 14 of ring 2″. Three-layer laminates are shown in both locations (elastomeric layers 15′ and 15″ with rigid layer 15′″ in the upper location and elastomeric layers 16′ and 16″ with rigid layer 16′″ in the lower location). The number of elastomeric layers can be smaller or greater in both locations.

In practical applications, springs can be exposed to aggressive environments, to elements, etc., thus calling for use of expensive materials less sensitive to the environmental effects. While fabrication of springs as shown in FIGS. 2 and 5 can use various technologies, there are technologies which can simultaneously generate elastomeric layers between the interacting rings and thin elastomeric coating of the spring as shown in FIG. 7 by numerals 17.

The embodiments shown in FIGS. 2, 3, 6 may lead to a presumption that elastomeric or laminated layers 7 continuously occupy all the contact areas between the conforming beveled surfaces. However, in many cases a much smaller surface area of the elastomeric layers/laminates is more than adequate to accommodate the compression forces acting on the elastomeric layers/laminates during deformation of the spring by an axial force P. Thus, a normal functioning of the spring would not be impaired if “patches” of elastomeric layers/laminates were used instead of continuous strips of elastomeric layers/laminates.

It is readily apparent that the components of the tension-compression spring disclosed herein may take a variety of configurations. Thus, the embodiments and exemplifications shown and described herein are meant for illustrative purposes only and are not intended to limit the scope of the present invention, the true scope of which is limited solely by the claims appended thereto.

1. A spring comprising at least one pair of external and internal rings, with a part of the inside surface of each said external ring being beveled and a part of the outside surface of each said internal ring being beveled, with end surfaces of the rings on the extreme surfaces of the spring contacting support surfaces by which axial forces are applied to the spring, with said beveled surfaces on said external and internal rings conforming by having the same bevel angles and being coaxially collocated and interacting in the assembled spring,
wherein said conforming and interacting beveled surfaces in the assembled spring are separated by at least one layer of a rubber-like material.

2. The spring of claim 1 wherein said layers of rubber-like materials are thin.

3. The spring of claim 1, wherein said conforming and interacting beveled surfaces in the assembled spring are separated by laminates comprising alternating layers of elastomeric material and layers of rigid material.

4. The spring of claim 1 wherein at least one layer of a rubber-like material is placed between said end surfaces of the rings on the extreme surfaces of the spring and support surfaces by which axial forces are applied to the spring,

5. The spring of claim 1 wherein said layers of rubber-like material cover the whole extent of the contact areas between said conforming and interacting beveled surfaces.

6. The spring of claim 3 wherein said layers of rubber-like material cover only parts of the contact areas between said conforming and interacting beveled surfaces.

7. The spring of claim 1 wherein surfaces of said rings outside of said conforming and interacting beveled surfaces are coated with a thin coating of a rubber-like material.
